(19) United States
(12) Patent Application Publication
(10) Pub. No.: US 2014/0278798 A1
(43) Pub. Date: Sep. 18, 2014

(54) SYSTEM AND METHOD FOR ESTIMATING CUSTOMER LIFETIME VALUE WITH LIMITED HISTORICAL DATA AND RESOURCES

(71) Applicants: Jitesh Goyal, Gurgaon (IN); Aniruddha Chatterjee, Gurgaon (IN); Aravindan Srinivasan, Patparganj (IN); Anand Premsundar, Gurgaon (IN); Alok Kumar, Gurgaon (IN); Gaurav A. Goyal, Dehli (IN); Sanjay Ojha, Gurgaon (IN)

(72) Inventors: Jitesh Goyal, Gurgaon (IN); Aniruddha Chatterjee, Gurgaon (IN); Aravindan Srinivasan, Patparganj (IN); Anand Premsundar, Gurgaon (IN); Alok Kumar, Gurgaon (IN); Gaurav A. Goyal, Dehli (IN); Sanjay Ojha, Gurgaon (IN)

(73) Assignee: Accenture Global Services Limited, Dublin 4 (IE)

(21) Appl. No.: 13/841,582

(22) Filed: Mar. 15, 2013

(51) Int. Cl. G06Q 30/02

(52) U.S. Cl. CPC G06Q 30/0204
USPC 705/7.33

(57) ABSTRACT

The present invention generally relates to estimating a customer's lifetime value to a company. The customer's lifetime value to the company can be based on remaining value of existing products and one or both of new purchase value and historic profitability. The remaining value and new purchase value for the customer may be estimated based on the customer's current customer segment and the customer's predicted future migration to a different customer segment. In addition, the remaining value may be estimated based on expected customer attrition, and the new purchase value may be estimated based on expected individual customer purchases.

### FIELD OF THE INVENTION

This invention relates generally to estimating a customer's value to a company.

### BACKGROUND OF THE INVENTION

Companies are increasingly shifting their marketing strategies from a product-centric approach to a customer-centric approach. This is due in part to substantial customer acquisition costs. Thus, companies tend to focus their marketing budget on acquiring and maintaining profitable customers.

Expending resources on cost management can adversely affect revenue growth, and vice-versa. When a company emphasizes one of these approaches, it can lose out on the other. For instance, if a company focuses on revenue growth without attending to cost management, it can fail to maximize profitability. Similarly, cost management without revenue growth can adversely affect the market performance of the company. What is needed is an approach that balances the two, creating market-based growth while carefully evaluating the profitability and return on marketing investments. Intelligent allocation of resources and efforts across profitable customers, and the use of cost-effective and customer-specific communication channels is part of such an approach. Such an approach would benefit from an accurate assessment of the value of individual customers.

### SUMMARY

According to some embodiments, a method for estimating lifetime value of a customer to a company is presented. The method includes tracking, for each segment of a plurality of customer segments, at least one segment-level aggregate profit driver among customers over a first historic time period, where the plurality of customer segments partition a plurality of company customers. The method also includes tracking customer migrations between the plurality of customer segments over the first historic time period. The method further includes estimating, for each segment among the plurality of customer segments, and based on the customer migrations between segments over the first historic time period and the at least one segment-level aggregate profit driver among customers over the first historic time period, at least one segment-level aggregate profit driver over a second future time period. The method further includes estimating, for a given customer, and based on the at least one segment-level aggregate profit driver over the second future time period, a remaining value of products of the given customer. The method further includes estimating, for the given customer, and based on the remaining value of products of the given customer, a lifetime profit value for the given customer. The method further includes sending a communication to the given customer based on the lifetime profit value for the given customer.

Various optional features of the above method include the following. The plurality of customer segments can be defined by at least one of customer age, customer location, customer demographics, and customer transactions. The method can further include estimating a lifetime new purchase value of the given customer, where the lifetime profit value for the given customer further includes the lifetime new purchase value of the given customer. The method can further include determining a historic profit value of the given customer, where the lifetime profit value for the given customer further includes the historic profit value of the given customer. The communication to the given customer can include a targeted marketing promotion. The method can further include modeling a cost-to-serve value for the given customer, where the targeted marketing promotion is based on the cost-to-serve value for the given customer. The communication to the given customer can include one of a loyalty program promotion and a rewards program promotion. The method can further include tracking, for each segment of the plurality of customer segments, a plurality of segment-level aggregate profit driver among customers over the first historic time period. The first historic time period may be limited to three years or less. The lifetime profit value for the given customer can consist of the remaining value of products of the given customer.

According to some embodiments, a system for estimating lifetime value of a customer to a company is presented. The system includes at least one processor, and a memory coupled to the at least one processor and having instructions stored thereon which, when executed by the at least one processor, cause the at least one processor to perform the following operations. The operations include tracking, for each segment of a plurality of customer segments, at least one segment-level aggregate profit driver among customers over a first historic time period, where the plurality of customer segments partition a plurality of company customers. The operations also include tracking customer migrations between the plurality of customer segments over the first historic time period. The operations further include estimating, for each segment among the plurality of customer segments, and based on the customer migrations between segments over the first historic time period and the at least one segment-level aggregate profit driver among customers over the first historic time period, at least one segment-level aggregate profit driver over a second future time period. The operations further include estimating, for a given customer, and based on the at least one segment-level aggregate profits driver over the second future time period, a remaining value of products of the given customer. The operations further include estimating, for the given customer, and based on the remaining value of products of the given customer, a lifetime profit value for the given customer. The operations further include sending a communication to the given customer based on the lifetime profit value for the given customer.

Various optional features of the above system include the following. The plurality of customer segments can be defined by at least one of customer age, customer location, customer demographics, and customer transactions. The memory coupled to the at least one processor can have further instructions stored thereon which, when executed by the at least one processor, cause the at least one processor to perform operations including: estimating a lifetime new purchase value of the given customer, where the lifetime profit value for the given customer further includes the lifetime new purchase value of the given customer. The memory coupled to the at least one processor can have further instructions stored thereon which, when executed by the at least one processor, cause the at least one processor to perform operations including: determining a historic profit value of the given customer, where the lifetime profit value for the given customer further includes the historic profit value of the given customer. The communication to the given customer can include a targeted marketing promotion. The memory coupled to the at least one processor can have further instructions stored thereon which, when executed by the at least one processor, cause the at least one processor to perform operations including: modeling a cost-to-serve value for the given customer, where the targeted marketing promotion is based on the cost-to-serve value for the given customer. The communication to the given customer can include one of a loyalty program promotion and a rewards program promotion. The memory coupled to the at least one processor can have further instructions stored thereon which, when executed by the at least one processor, cause the at least one processor to perform operations including: tracking, for each segment of the plurality of customer segments, a plurality of segment-level aggregate profit driver among customers over the first historic time period. The first historic time period may be limited to three years or less. The lifetime profit value for the given customer can consist of the remaining value of products of the given customer.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is a schematic diagram of a customer lifetime value assessment according to some embodiments;

FIG. 2 is a schematic diagram of an implementation framework according to some embodiments;

FIG. 3 is a schematic diagram of tracking customer segments according to some embodiments;

FIG. 4 is a flowchart of a method according to some embodiments; and

FIG. 5 is a schematic diagram of a system according to some embodiments.

### DESCRIPTION OF THE EMBODIMENTS

Reference will now be made in detail to the present embodiments (exemplary embodiments) of the invention, examples of which are illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Companies have limited resources and want to invest in those customers who bring maximum return. Various embodiments consistent with the invention provide techniques for identifying such customers by determining the cumulated cash flow of a customer over his or her entire lifetime with the company. Allocating resources for profitable customers and using customer-specific communication channels may greatly benefit from an accurate assessment of the customers' value as provided by various embodiments consistent with this disclosure. For example, determining customer lifetime value for a company's customers helps the company know how much it can invest in retaining each customer so as to achieve positive return on investment. Once a company has calculated customer lifetime value of their customers, it can optimally allocate its limited resources to achieve maximum return. Furthermore, various embodiments may provide a customer lifetime value framework that can form the basis for purchase sequence analysis and customer-specific communication strategies. Thus, customer lifetime value can be considered a metric that guides the allocation of resources for ongoing marketing activities in a company that adopts a customer-centric approach. In other words, a customer lifetime value, as calculated by various embodiments consistent with the invention, may help the company treat each customer in a manner that is appropriate based on their contribution to the company's profits.

According to some implementations, techniques for estimating customer lifetime value are presented. In general, customers' value to a company can be based on their contribution to the company across the duration of their relationship with the company. While past contributions to profit can be assessed without the need for estimating, total profitability of the customer to the firm can also account for future contributions to profit.

While the present discussion references, at times, a bank, the invention is not limited to banks. Indeed, various embodiments or implementations of the invention can be used by any company that has customers and would like to assess lifetime values for those customers for various purposes, such as directing marketing, advertising, servicing, and other efforts toward the most profitable customers.

FIG. 1 is a schematic diagram of a customer lifetime value assessment according to some embodiments. According to some implementations, customer lifetime value 110 is based on both historic profitability 108 and future value 106 of the customer. Historic profitability can be determined by examining records kept for the customer by the company. Future value 106 can be based on both remaining value 102 of existing customer products (e.g., products and services the customer is currently purchasing from the company) and new purchase value 104, which accounts for expected future customer products, such as the customer's future purchase of new products and new services that the customer has not purchased before. This can be expressed as, for example:

FV(c)=Σₚexpected_remaining_valueₚ+Σ_{f}potential_{—}new_value_{f} (1)

In Equation (1) above, FV(c) represents the estimated future value of customer c, expected_remaining_valueₚ represents the expected remaining value of product p already in the portfolio of customer c, where the first sum is over all such products, and potential_new_value_{f} represents the expected value of new product f for customer c, where the second sum is over all new products f that customer c is expected or predicted to purchase. As used herein, “product” includes both products and services.

Each term in each summation in Equation (1) above can be broken out as functions of time. For example, according to some implementations, each expected_remaining_valueₚ can be represented as, by way of non-limiting example:

$$expected\_remaining \_value ( p , n ) = {\sum }_{t = 1}^{n} \{ \frac{( Income ( t ) - Cost ( t ) )}{{( 1 + d )}^{t}} \times ( 1 - AR ( c ) ) \} \qquad ( 2 )$$

In Equation (2) above, expected_remaining_valueₚ represents the expected remaining value of product p already in the portfolio of customer c after n years, Income(t) represents the predicted revenue generated by customer c from product p in year t, Cost(t) represents the cost incurred during marketing, operation, and other activities and expended related to product p in year t, d is a discount rate used to account for the time value of money, and AR(c) is the attrition rate of customer c relative to product p (e.g., the probability that customer c will fail to, or no longer, purchase product p in year t).

Further, according to some implementations, each potential_new_value_{f} can be represented as, by way of non-limiting example:

$$potential\_new \_value ( f , n ) = {\sum }_{t = 1}^{n} \{ \frac{( Income ( t ) - Cost ( t ) )}{{( 1 + d )}^{t}} \times ( buying\_propensity ( c ) ) \} \qquad ( 3 )$$

In Equation (3) above, potential_new_value_{f} represents the value of new product f for customer c after n years, Income(t) represents the predicted revenue generated by customer c from new product f in year t, Cost(t) represents the cost incurred during marketing, operation, and other activities and expenses related to new product f in year t, d is a discount rate used to account for the time value of money, and buying_propensity(c) represents the propensity for customer c to purchase new product f (e.g. the probability that customer c will buy product f, which is a product that customer c has not purchased before).

In sum, future value 106 can be represented by Equation (1) and can include both remaining value 102 and new purchase value 104. Remaining value 102 can be represented by Equation (2), and new purchase value 104 can be represented by Equation (3). Historic profitability 108 can be determined by examining records kept for customer c. Each of these values 102, 106, 108 can be accounted for in expressing customer lifetime value 110.

It is found that remaining value 102 alone captures most (e.g., 70-80%) of customer lifetime value 110. Accordingly, various embodiments consistent with the invention may produce a robust approximation of customer lifetime value 110 by focusing on remaining value 102 alone or more heavily weighted than remaining value 102 and/or historic profitability 108. Thus, in some implementations, customer lifetime value 110 is based on remaining value 102 alone; in other implementations, customer lifetime value 110 is based on remaining value 102 and one or both of new purchase value 104 and historic profitability 108.

An example of determining a customer lifetime value based on remaining value 102 and new purchase value 104 follows. A hypothetical customer, Mr. C, banks at Bank X. Mr. C has banked at Bank X for ten years and has had a savings account and a credit card since becoming a Bank X customer. His future value 106 can accordingly be calculated according to Equations 1-3. For purposes of the determination, a discount rate of 15% is assumed without loss of generality. Also, a buying propensity of 30% is assumed for Mr. C's purchase of Bank X's loans, and a buying propensity of 50% is assumed for Mr. C's purchase of Bank X's mortgages. Additionally, an attrition rate of 10% is assumed for Mr. C's propensity to attrite from any Bank X product. The following Table 1 depicts example predicted income and cost values for products either currently or potentially utilized by Mr. C.

TABLE 1

| | Predicted Income | | | Predicted Cost | | |
|---|---|---|---|---|---|---|
| | Yr1 | Yr2 | Yr3 | Yr1 | Yr2 | Yr3 |
| Savings | 1000 | 1500 | 2000 | 900 | 1300 | 1800 |
| Credit Card | 500 | 1000 | 1500 | 450 | 800 | 1200 |
| Loans | 500 | 600 | 600 | 400 | 450 | 450 |
| Mortgage | 400 | 400 | 400 | 350 | 300 | 300 |

With these parameters, we can compute the following customer lifetime value, assuming without loss of generality a customer lifetime of three years for Mr. C at Bank X. The computations, based on Equations 2 and 3, can proceed as follows, by way of non-limiting example.

Savings (Remaining Value):

$$\frac{1000 - 900}{( 1 + 0.15 )} ( 1 - 0.10 ) + \frac{1500 - 1300}{{( 1 + 0.15 )}^{2}} ( 1 - 0.10 ) + \frac{2000 - 1800}{{( 1 + 0.15 )}^{3}} ( 1 - 0.10 ) = 333 \qquad ( 4 )$$

Credit Card (Remaining Value):

$$\frac{500 - 450}{( 1 + 0.15 )} ( 1 - 0.10 ) + \frac{1000 - 800}{{( 1 + 0.15 )}^{2}} ( 1 - 0.10 ) + \frac{1500 - 1200}{{( 1 + 0.15 )}^{3}} ( 1 - 0.10 ) = 352 \qquad ( 5 )$$

Loans (New Purchase Value):

$$\frac{500 - 400}{( 1 + 0.15 )} ( 0.3 ) + \frac{600 - 450}{{( 1 + 0.15 )}^{2}} ( 0.3 ) + \frac{600 - 450}{{( 1 + 0.15 )}^{3}} ( 0.3 ) = 90 \qquad ( 6 )$$

Mortgage (New Purchase Value):

$$\frac{400 - 350}{( 1 + 0.15 )} ( 0.5 ) + \frac{400 - 3000}{{( 1 + 0.15 )}^{2}} ( 0.5 ) + \frac{400 - 300}{{( 1 + 0.15 )}^{3}} ( 0.5 ) = 92 \qquad ( 7 )$$

Customer Lifetime Value:

333+352+90+92=867 (8)

Thus, as shown above, a total lifetime value of Mr. C to Bank X can be $867, based on remaining value 102 and new purchase value 104.

FIG. 2 is a schematic diagram of an implementation framework according to some embodiments. The example framework measures expected remaining value and future value (if used) for each product separately. The framework then accumulates these values to obtain customer lifetime value metrics for each customer.

The framework thus aggregates and summarizes company data 202 at the product and customer level. Company data 202 includes customer demographic data 204 (e.g., age, tenure, location) transactional behavior data 206 (e.g., frequency, recency, volume) and profitability data 208 (e.g., components of income and cost). Company data 202 are linked together and segregated for each product. Company data 202 is used as input to calculate remaining value and new purchase value for each product.

The framework also includes remaining value engine 212. In the embodiment shown, remaining value engine 212 includes three sub-engines. First, remaining value engine 212 includes customer segmentation engine 214. Segmentation engine 214 imposes segments to the totality of customers based on, e.g., similar profitability behavior. Further details of customer segmentation are described below in reference to FIG. 3. Second, remaining value engine 212 includes forecasting engine 216. Forecasting engine 216 forecasts revenue, cost and loss drivers for each customer segment. Third, remaining value engine 212 includes remaining value aggregation engine 218. Remaining value aggregation engine 218 aggregates the segment-level remaining value determinations of forecasting engine 216. Using engines 214, 216 and 218, remaining value engine 212 outputs remaining value determinations 220 at the product level.

The framework also includes future information engine 224. Future information engine 224 includes attrition model 222, which affects consideration of remaining value determinations 220. Attrition engine 222 thus estimates customer attrition on a product-by-product basis. Future information engine 224 also includes new value engine 226. New value engine 226 calculates customer profit from new purchase value events. For example, new value engine can implement Equation (3) above. New value engine 226 itself includes customer buying propensity model 228 and product new purchase value engine 230. Buying propensity model 228 estimates customer propensity to purchase new products. Buying propensity model 228 performs such calculations for each new product at the customer segment level. Product new purchase value engine 226 estimates profit from new purchases for each new product.

FIG. 3 is a schematic diagram of tracking customer segments according to some embodiments. An objective of customer segmentation is to group customers who are likely to show similar profitability behavior. Some embodiments forecast profitability levers at the segment level and subsequently use this to arrive at customer value. Thus, segmentation can be done such that each customer in a segment shows behavior that drives similar profitability.

In order to segment customers, a company can analyze transaction characteristics and/or customer demographic characteristics. These characteristics affect how certain customers are more profitable than others. For example, for a credit card business, transaction characteristics such as customer balance and customer spend are typically the most critical drivers for profitability, and the type of balance held would drive how margins and fees grow. Customer segmentation can accordingly be performed based on these characteristics using various known techniques, such as Chi-squared Automatic Interaction Detection (“CHAID”). However simple exploratory analysis and customer profiling on profitability metrics can also reveal behaviors leading to differential profitability.

Once segmented, some embodiments track customer migration from segment to segment. Customers exhibit different behavior at various stages of a product engagement cycle. That is, customers move from one segment to another over time; thus, segment composition can change. Some embodiments track such migration among segments, and then use the tracking data to model, estimate, or predict the future migration of a customer from the customer's current segment to another segment.

For example, FIG. 3 depicts tracking customers among four different segments 310, 312, 314, 316. In particular, FIG. 3 illustrates tracking customers initially in segment one 308. As shown in FIG. 3, each segment has a profitability trajectory 302 based on historic trends within each segment. At any given present time 304, however, customers can migrate between segments. For example, some customers currently in segment one 308 might be expected to move to other segments. As illustrated, among customers currently in segment one 308, 30% move to segment two 310, 20% move to segment three 314, 10% move to segment four 316, and 40% remain in segment one 312 at a future time 306. Thus, while historic trends might indicate a tentative customer profitability projection 320, after incorporating segment migration into the projection, the customer profitability trend might change to a more accurate projection 318. This migration can be quantized for example, as follows:

Forecasted_value_{seg1}=0.4×Proj_{seg1}+0.3×Proj_{seg2}+0.2×Proj_{seg3}+0.1×Proj_{seg4} (9)

In Equation (9) above, Forecasted_value_{seg1} represents a forecasted value of segment one customers, and each Proj_{segx} represents a projected value of segment x, for x from one to four.

In various embodiments, the model shown in FIG. 3 and described by Equation (9) may be employed by the remaining value engine 212 of FIG. 2 or by boxes 404 and/or 406 of the exemplary method shown in FIG. 4.

FIG. 4 is a flowchart of a method according to some embodiments. At block 402, the technique tracks segment-level aggregate profit, e.g., relying on company data 202 and segmentation engine 214. Some embodiments forecast actual trends of behavior using historical data. Limited historical data of, for example, the past one, two, or three years can be used to forecast future behavior.

As an example of block 402, an embodiment can use two years of data to understand the change in balance behavior over time for sample segments. Though the example used herein is balance, embodiments can generally perform the technique for each profit driver (e.g., customer spend, customer balance) and aggregate the results. Example steps for plotting an actual trend curve can be as follows. First, take all the accounts that were active two years back from the current time. Second, fetch balance history of these accounts for each quarter two years back (eight quarters total). Third, map the segment (defined earlier using customer segmentation approach) to these accounts—both current and before two years. Fourth, sum the balance values at the segment level to get segment level balance data for eight quarters. Finally, compute segment-level profit from the individual profit drivers. In various embodiments, the processing and operations described in this paragraph may utilize company data 202. An example of segment level balance data appears in Table 2 below.

TABLE 2

| Segments | -Q8 | -Q7 | -Q6 | -Q5 | -Q4 | -Q3 | -Q2 | -Q1 | Q-current |
|---|---|---|---|---|---|---|---|---|---|
| Segment 1 | 79.48 | 76.64 | 73.79 | 72.91 | 68.48 | 63.05 | 58.25 | 54.28 | 49.58 |
| Segment 2 | 22.97 | 20.24 | 17.41 | 17.04 | 12.44 | 9.13 | 7.72 | 7.17 | 6.80 |
| Segment 3 | 56.71 | 52.74 | 45.66 | 45.13 | 38.32 | 34.53 | 32.55 | 30.28 | 28.03 |
| Segment 4 | 34.65 | 39.01 | 37.59 | 36.67 | 35.80 | 37.61 | 37.30 | 37.22 | 34.00 |
| Segment 5 | 33.22 | 33.83 | 32.42 | 31.88 | 30.93 | 29.78 | 28.81 | 27.75 | 26.03 |

In Table 2 above, −Qx indicates a quarter x quarters prior to the present time, and Q-current indicates the current quarter. The example figures in Table 2 are understood to be in millions of U.S. dollars.

Next, using the data of Table 2, growth can be calculated, e.g., by remaining value engine 212, using a quarter-over-quarter approach to normalize the data. Table 3 below reflects this approach applied to Table 2.

TABLE 3

| Seg- | | | | | | | | | Q- |
|---|---|---|---|---|---|---|---|---|---|
| ments | -Q8 | -Q7 | -Q6 | -Q5 | -Q4 | -Q3 | -Q2 | -Q1 | current |
| Segment | 1 | 0.964 | 0.928 | 0.917 | 0.862 | 0.793 | 0.733 | 0.683 | 0.624 |
| 1 | | | | | | | | | |
| Segment | 1 | 0.881 | 0.758 | 0.742 | 0.542 | 0.398 | 0.336 | 0.312 | 0.296 |
| 2 | | | | | | | | | |
| Segment | 1 | 0.930 | 0.805 | 0.796 | 0.676 | 0.609 | 0.574 | 0.534 | 0.494 |
| 3 | | | | | | | | | |
| Segment | 1 | 1.126 | 1.085 | 1.058 | 1.033 | 1.085 | 1.077 | 1.074 | 0.981 |
| 4 | | | | | | | | | |
| Segment | 1 | 1.018 | 0.976 | 0.960 | 0.931 | 0.896 | 0.867 | 0.835 | 0.783 |
| 5 | | | | | | | | | |

Table 3 reflects the results of dividing each of the balances appearing in Table 2 by the −Q8 balance for each respective segment. Thus, for example, for Segment 1, the −Q7 balance can be computed as the product of 0.964 and an actual −Q8 balance.

At block 404, the technique tracks segment-level migration among segments using, e.g., segmentation engine 214. Some embodiments consider change in segment characteristics of each account in the forecasting calculation performed by e.g., forecasting engine 216. Understanding the behavior of the account over time thus assists in forecasting profit. Segments can be defined, e.g., by segmentation engine 214, based on profit driving parameters. So there is a probability of segment change for the customers depending on shifts on these parameters. To analyze segment migration patterns, the following steps can be implemented, e.g., by segmentation engine 214 and/or forecasting engine 216. First, all the accounts that were active two years back are mapped with their respective segment based on characteristics two years back. Second, the same accounts are also mapped with the segments based on present characteristics (e.g., whether the accounts are still in existence). Third, a movement matrix is generated showing how customers from segments two years back have moved into different segments after six quarters. Table 4 below illustrates an example movement matrix.

TABLE 4
Segments after 2 years (Q-Current)

| | | Segment | Segment | Segment | Segment | Segment |
|---|---|---|---|---|---|---|
| | | 1 | 2 | 3 | 4 | 5 |
| Base | Segment 1 | 80% | 3% | 2% | 8% | 7% |
| Segments, | Segment 2 | 5% | 67% | 8% | 9% | 11% |
| -Q8 | Segment 3 | 8% | 6% | 71% | 10% | 5% |
| | Segment 4 | 12% | 7% | 11% | 65% | 5% |
| | Segment 5 | 5% | 2% | 3% | 1% | 89% |

For example, for Segment 4 above in Table 4, 65% of customers remain in Segment 4, and the remaining 35% migrate across different segments.

The segment migration patterns illustrated by the movement matrix of Table 4 can be iterated, e.g., by forecasting engine 216, in order to extrapolate migration among segments in the future. Table 5 below illustrates segment migration after four years (thus iterating the movement of Table 4 twice), and Table 6 below illustrates segment migration after six years (thus iterating the movement of Table 4 three times).

TABLE 5
Segments after 4 years

| | | Segment | Segment | Segment | Segment | Segment |
|---|---|---|---|---|---|---|
| | | 1 | 2 | 3 | 4 | 5 |
| Base | Segment 1 | 66% | 5% | 4% | 12% | 13% |
| Segments, | Segment 2 | 10% | 46% | 12% | 13% | 18% |
| -Q8 | Segment 3 | 14% | 9% | 52% | 15% | 10% |
| | Segment 4 | 19% | 10% | 16% | 45% | 10% |
| | Segment 5 | 9% | 4% | 5% | 2% | 80% |

TABLE 6
Segments after 6 years

| | | Segment | Segment | Segment | Segment | Segment |
|---|---|---|---|---|---|---|
| | | 1 | 2 | 3 | 4 | 5 |
| Base | Segment 1 | 48% | 8% | 8% | 15% | 21% |
| Segments, | Segment 2 | 17% | 25% | 16% | 16% | 27% |
| -Q8 | Segment 3 | 21% | 12% | 32% | 18% | 18% |
| | Segment 4 | 25% | 12% | 18% | 26% | 18% |
| | Segment 5 | 14% | 6% | 8% | 5% | 66% |

The iteration matrices of Tables 5 and 6 are created based on the reasonable assumption that the split of every segment would be similar after every two-year period (e.g., as based on the data of Table 4). For Example, if Segment 1 splits into 80% Segment 1 and 20% to other segments at the end of two years, then it is an intuitive assumption that Segment 1 will continue such behavior.

At block 406, the technique estimates future segment-level aggregate profits, e.g., using remaining value engine 212, based on the data collected per blocks 402 and 404. Essentially, the output of block 406 includes information from the outputs of blocks 402 and 404. Thus, actual trending data is combined with segment migration data, and normalized aggregate profits are weighted accordingly. Table 7 below illustrates an example of such combination as applied to balance as reflected in Tables 3 and 4 above. In particular, Table 7 below depicts forecasting for Segment 3 only. Forecasting for the other segments is performed similarly.

TABLE 7

| Split of | | | | | | | | | |
|---|---|---|---|---|---|---|---|---|---|
| Segment 3 | | | | | | | | | |
| into 5 | Q- | | | | | | | | |
| segments | Current | | | | | | | | |
| at the end | Slope for | | | | | | | | |
| of 2 Years | Seg. 3 | Q1 | Q2 | Q3 | Q4 | Q5 | Q6 | Q7 | Q8 |
| Seg.1: | 0.494 | 0.038 | 0.037 | 0.036 | 0.034 | 0.031 | 0.029 | 0.027 | 0.025 |
| 8% | | | | | | | | | |
| Seg. 2: | 0.494 | 0.026 | 0.022 | 0.022 | 0.016 | 0.012 | 0.010 | 0.009 | 0.009 |
| 6% | | | | | | | | | |
| Seg. 3: | 0.494 | 0.326 | 0.282 | 0.279 | 0.237 | 0.214 | 0.201 | 0.187 | 0.173 |
| 71% | | | | | | | | | |
| Seg. 4: | 0.494 | 0.056 | 0.054 | 0.052 | 0.051 | 0.054 | 0.053 | 0.053 | 0.048 |
| 10% | | | | | | | | | |
| Seg. 5: | 0.494 | 0.025 | 0.024 | 0.024 | 0.023 | 0.022 | 0.021 | 0.021 | 0.019 |
| 5% | | | | | | | | | |
| Weighted | | 0.471 | 0.419 | 0.413 | 0.361 | 0.332 | 0.315 | 0.297 | 0.275 |
| Sum | | | | | | | | | |

Note that the quarters characterized in Table 7 above are future quarters. To derive Table 7 above using, e.g., remaining value engine 212, an example computation can be as follows. First, the first column is populated with segment migration data, which is taken from the row for Segment 3 of Table 4. Next, the second column is populated with the Q-current aggregate data for Segment 3, in this case taken from Table 3 above. As an example computation, the aggregate balances for customers starting out in Segment 3 but winding up in Segment 2 after one quarter (i.e., in Q1) can be computed by taking the product of (A) the split of Segment 3 into Segment 2 at the end of two years from the first column of Table 7 above (i.e., 0.06), (B) the portion of such customers currently in Segment 3 from the second column of Table 7 above (i.e., 0.494), and (C) the quarter-over-quarter value for −Q7 for Segment 2 taken from Table 3 above (i.e., 0.881). Thus, the aggregate balances for customers starting out in Segment 3 but winding up in Segment 2 after one quarter can be computed as 0.06×0.494×0.881=0.026, as reflected in the third row of the third column of Table 7 above.

To complete Table 7 above, the parameters are summed in each column, yielding a weighted sum of aggregate balances, taking segment migration into account. Finally, each profit driver (including balance, as illustrated above) is summed to arrive at a total profit estimate. Though illustrated for Segment 3 in the above tables, embodiments can perform these calculations for each segment.

At block 408, the technique estimates a remaining value for an individual customer using e.g., remaining value engine 212. Given the data developed up to this point in the technique, the calculation of future value for an individual customer may be performed. Indeed, for an individual customer in Segment 3 having an initial value of $100, to extrapolate the customer's future value based on existing products into the future Q1, multiply $100 by the aggregated value in the last row of Table 7 corresponding to Q1, that is, $100×0.471=$47.10. In some implementations, this extrapolation is continued for an estimated customer lifetime duration. The duration can be based on empirical data observed by the company (e.g., customer performance/behavioral data), on demographic data, or on other data.

At block 410, the technique estimates a customer lifetime value for an individual customer. In some implementations the customer lifetime value is taken to be the remaining value as determined at block 408. In other embodiments, the customer lifetime value is taken to be the sum of the remaining value as determined at block 408 and one or both of a customer new purchase value and a customer historic profitability. These additional quantities can be determined as discussed herein. E.g., a customer historic profitability can be determined by examining historic customer records, and a new purchase value can be determined as illustrated above in reference to Equation (3).

At block 412, the technique sends a communication to the customer, e.g., using network interface 508 of FIG. 5 below, based on the estimated customer lifetime value. Such communications can include rewards program offers, incentives (e.g., coupons, vouchers, etc.), discounts, marketing materials (e.g., advertisements), and any of the preceding in any combination. Such communications can take any of several forms. In some implementations, the communications are performed telephonically, by phoning the customer. In some implementations, the communications are performed electronically, e.g., by emailing the customer. In some implementations, the communications are performed using mail, e.g., USPS.

The communication can be based on the customer's lifetime value in any of several ways. For example, the communication can be part of a targeted marketing campaign, where the campaign is targeted at customers in a particular lifetime value range. As another example, the communication can be based on a cost-to-serve model. That is, the communication can take into account the cost-to-serve the customer as compared to the customer lifetime value of the customer. If the latter is greater than the former, then the company would likely profit by providing incentives, offers, or other information to the customer. As yet another example, the communication can be directed to customers that, based on their lifetime values, are likely to move into a segment of higher-value customers. Such customers can be regarded as good investments for the company's marketing resources.

FIG. 5 is a schematic diagram of a system according to some embodiments. In particular, FIG. 5 illustrates various hardware, software, and other resources that may be used in implementations of the present invention according to disclosed systems and methods. For example, one or more systems as shown in FIG. 5 may be used to implement Equations (1)-(3), to implement remaining value engine 211 and/or future information engine 224 of FIG. 2, to implement the operations, methods or processes described in FIG. 4, or the like. In embodiments as shown, computer system 506 may include one or more processors 510 coupled to random access memory operating under control of or in conjunction with an operating system. The processors 510 in embodiments may be included in one or more servers, clusters, or other computers or hardware resources, or may be implemented using cloud-based resources. The operating system may be, for example, a distribution of the Linux™ operating system, the Unix™ operating system, or other open-source or proprietary operating system or platform. Processors 510 may communicate with persistent memory 512, such as a database stored on a hard drive or drive array, to access or store program instructions or other data such as company data 202.

Processors 510 may, in general, be programmed or configured to execute control logic and control operations to implement methods disclosed herein. Processors 510 may be further communicatively coupled (i.e., coupled by way of a communication channel) to co-processors 514. Co-processors 514 can be dedicated hardware and/or firmware components configured to execute the methods, equations, and techniques disclosed herein, such as those described in reference to FIGS. 1-4. Thus, the methods, equations, and techniques disclosed herein can be executed by processor 510 and/or co-processors 514. Other configurations of computer system 506, associated network connections, and other hardware, software, and service resources are possible.

Processors 510 may further communicate via a network interface 508, which in turn may communicate via the one or more networks 504, such as the Internet or other public or private networks, such that a communication may be sent to client 502, or other device or service. Additionally, processors 510 may utilize network interface 508 to send information or other data to a user via the one or more networks 504. Network interface 504 may include or be communicatively coupled to one or more servers. Client 502 may be, e.g., a personal computer coupled to the internet.

Certain embodiments can be performed as a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method for estimating lifetime value of a customer to a company, the method comprising:
tracking, for each segment of a plurality of customer segments, at least one segment-level aggregate profit driver among customers over a first historic time period, wherein the plurality of customer segments partition a plurality of company customers;
tracking customer migrations between the plurality of customer segments over the first historic time period;
estimating, for each segment among the plurality of customer segments, and based on the customer migrations between segments over the first historic time period and the at least one segment-level aggregate profit driver among customers over the first historic time period, at least one segment-level aggregate profit driver over a second future time period;
estimating, for a given customer, and based on the at least one segment-level aggregate profit driver over the second future time period, a remaining value of products of the given customer;
estimating, for the given customer, and based on the remaining value of products of the given customer, a lifetime profit value for the given customer; and
sending a communication to the given customer based on the lifetime profit value for the given customer.

2. The method of claim 1, wherein the plurality of customer segments are defined by at least one of customer age, customer location, customer demographics, and customer transactions.

3. The method of claim 1, further comprising estimating a lifetime new purchase value of the given customer;
wherein the lifetime profit value for the given customer further comprises the lifetime new purchase value of the given customer.

4. The method of claim 1, further comprising determining a historic profit value of the given customer;
wherein the lifetime profit value for the given customer further comprises the historic profit value of the given customer.

5. The method of claim 1, wherein the communication to the given customer comprises a targeted marketing promotion.

6. The method of claim 5, further comprising:
modeling a cost-to-serve value for the given customer;
wherein the targeted marketing promotion is based on the cost-to-serve value for the given customer.

7. The method of claim 1, wherein the communication to the given customer comprises one of a loyalty program promotion and a rewards program promotion.

8. The method of claim 1, further comprising: tracking, for each segment of the plurality of customer segments, a plurality of segment-level aggregate profit driver among customers over the first historic time period.

9. The method of claim 1, wherein the first historic time period does not exceed three years.

10. The method of claim 1, wherein the lifetime profit value for the given customer consists of the remaining value of products of the given customer.

11. A system comprising:
at least one processor; and
a memory coupled to the at least one processor and having instructions stored thereon which, when executed by the at least one processor, cause the at least one processor to perform operations comprising:
tracking, for each segment of a plurality of customer segments, at least one segment-level aggregate profit driver among customers over a first historic time period, wherein the plurality of customer segments partition a plurality of company customers;
tracking customer migrations between the plurality of customer segments over the first historic time period;
estimating, for each segment among the plurality of customer segments, and based on the customer migrations between segments over the first historic time period and the at least one segment-level aggregate profit driver among customers over the first historic time period, at least one segment-level aggregate profit driver over a second future time period;
estimating, for a given customer, and based on the at least one segment-level aggregate profit driver over the second future time period, a remaining value of products of the given customer;
estimating, for the given customer, and based on the remaining value of products of the given customer, a lifetime profit value for the given customer; and
sending a communication to the given customer based on the lifetime profit value for the given customer.

12. The system of claim 11, wherein the plurality of customer segments are defined by at least one of customer age, customer location, customer demographics, and customer transactions.

13. The system of claim 11, wherein the memory coupled to the at least one processor has further instructions stored thereon which, when executed by the at least one processor, cause the at least one processor to perform operations comprising:
estimating a lifetime new purchase value of the given customer;
wherein the lifetime profit value for the given customer further comprises the lifetime new purchase value of the given customer.

14. The system of claim 11, wherein the memory coupled to the at least one processor has further instructions stored thereon which, when executed by the at least one processor, cause the at least one processor to perform operations comprising:
determining a historic profit value of the given customer;
wherein the lifetime profit value for the given customer further comprises the historic profit value of the given customer.

15. The system of claim 11, wherein the communication to the given customer comprises a targeted marketing promotion.

16. The system of claim 15, wherein the memory coupled to the at least one processor has further instructions stored thereon which, when executed by the at least one processor, cause the at least one processor to perform operations comprising:
modeling a cost-to-serve value for the given customer;
wherein the targeted marketing promotion is based on the cost-to-serve value for the given customer.

17. The system of claim 11, wherein the communication to the given customer comprises one of a loyalty program promotion and a rewards program promotion.

18. The system of claim 11, wherein the memory coupled to the at least one processor has further instructions stored thereon which, when executed by the at least one processor, cause the at least one processor to perform operations comprising: tracking, for each segment of the plurality of customer segments, a plurality of segment-level aggregate profit driver among customers over the first historic time period.

19. The system of claim 11, wherein the first historic time period does not exceed three years.

20. The system of claim 11, wherein the lifetime profit value for the given customer consists of the remaining value of products of the given customer.

21. A non-transitory computer readable medium comprising instructions, which, when executed by at least one processor, cause the at least one processor to perform operations comprising:
tracking, for each segment of a plurality of customer segments, at least one segment-level aggregate profit driver among customers over a first historic time period, wherein the plurality of customer segments partition a plurality of company customers;
tracking customer migrations between the plurality of customer segments over the first historic time period;
estimating, for each segment among the plurality of customer segments, and based on the customer migrations between segments over the first historic time period and the at least one segment-level aggregate profit driver among customers over the first historic time period, at least one segment-level aggregate profit driver over a second future time period;
estimating, for a given customer, and based on the at least one segment-level aggregate profit driver over the second future time period, a remaining value of products of the given customer;
estimating, for the given customer, and based on the remaining value of products of the given customer, a lifetime profit value for the given customer; and
sending a communication to the given customer based on the lifetime profit value for the given customer.

22. A method for estimating lifetime value of a customer, the method comprising:
defining a plurality of customer segment, wherein the plurality of customer segments partition a plurality of customers;
determining an aggregate remaining value for each customer segment, wherein the aggregate remaining value comprises, for each of a plurality of products, a sum of differences between income and cost for a given product discounted according to a discount rate and weighted according to an attrition rate;
determining a particular customer segment corresponding to a particular customer;
estimating, using an aggregate remaining value corresponding to the particular customer segment, and based on historical data reflecting customer migration between segments, a particular remaining value for the particular customer;
determining a customer offer corresponding to the particular remaining value; and
providing the customer offer to the particular customer.

23. The method of claim 22, wherein each sum of differences between income and cost for a given product discounted according to a discount rate and weighted according to an attrition rate is provided by the formula
$${\sum }_{t = 1}^{n} \{ \frac{( Income ( t ) - Cost ( t ) )}{{( 1 + d )}^{t}} \times ( 1 - AR ( c ) ) \} ,$$
where n represents a length of time, Income(t) represents an income from the given product at time t, Cost(t) represents a cost from the given product at time t, d represents the discount rate, and AR(c) represents an attrition rate of the given customer c.
